(19) United States
(12) Patent Application Publication
(10) Pub. No.: US 2026/0191201 A1
(43) Pub. Date: Jul. 9, 2026

(54) COATED STEEL STRIP WITH ANTIMICROBIAL COPPER LAYER FOR AIR-HANDLING SYSTEMS

(71) Applicant: VOESTALPINE STAHL GMBH, Linz (AT)

(72) Inventors: Karl-Heinz STELLNBERGER, Linz (AT); Wolfgang BURGSTALLER, Linz (AT)

(21) Appl. No.: 19/133,093

(22) PCT Filed: Nov. 29, 2023
(86) PCT No.: PCT/EP2023/083474

§ 371 Date: May 27, 2025

(30) Foreign Application Priority Data
Nov. 30, 2022 (EP) 22210623.9

(51) Int. Cl. A01N 59/20; A01N 59/16; A01P 1/00; B32B 15/01; C09D 1/00

(52) U.S. Cl. CPC A01N 59/20; A01N 59/16; A01P 1/00; B32B 15/015; C09D 1/00; B32B 2250/03; B32B 2307/7376; B32B 2311/12; B32B 2311/20; B32B 2311/30

(57) ABSTRACT

With reference to technical systems there is disclosed a coating for a steel strip, a coated steel strip, a method for producing the coating, and an air-handling system with the coating. The coating has a zinc layer for placement directly on the surface of the steel strip and a copper layer arranged on the zinc layer. The copper layer has formed with openings. The zinc layer is only partially covered by the copper layer.

The invention relates to an antimicrobial coating for a steel strip, to a coated steel strip, to a method for producing the coating and to applications of antimicrobial coatings, such as air-handling (AH) systems.

Air-handling systems are used to control the air quality in rooms. They are installed in many different areas, wherein air-handling systems may be designed for individual rooms as well as for entire buildings or structural systems, such as subway systems. The remodeling or renovation of an air-handling system is very expensive, as on the one hand, the rooms cannot be fully used during the remodeling phase and, on the other hand, there are high investment costs. Therefore, air-handling systems usually have a long service life of at least 20 years.

Air-handling systems comprise at least one interior space for routing air, through which an air flow may be routed into a room or out of a room. For this purpose, often long air duct systems consisting of different components are installed. The individual components may be connected, for example, via connectors, threaded connectors or by welding. In order to generate a regulated air flow, a fan is usually comprised. Based on the respective requirements, the air ducts may have an interior height of several meters, and they usually have a round or angular cross-section. The design of air-handling systems is regulated in various standards, for example in DIN EN 1505:1998-2 and DIN EN 1506:2007-9, or in DIN 1946-7: 2022-08, which is relevant for laboratories. It often stipulates additional components, such as filters, humidifiers, dehumidifiers, heating elements, cooling elements or other functional elements, in order to achieve the desired air quality.

An essential quality criterion for assessing the air quality is the amount of pathogens contained in the air. This allows airborne bacteria, fungi, spores and viruses to be spread by air-handling systems. Therefore, air-handling systems are subject to very strict hygiene controls, especially in public spaces and in the medical and food sectors. The air quality not meeting the required limits may lead to closures and thus to major economic damage. Therefore, during maintenance of the systems, it is important to ensure that there will not be any deposits in the interior of the air-handling system in which pathogens could settle or even multiply. However, cleaning the systems is often very complex and only possible using special equipment. Since the air-handling system cannot be used during maintenance, it should still be possible to clean the system as quickly as possible.

Air-handling systems are usually made of galvanized steel. However, deposits of viruses, bacteria and fungi during the operation of AH systems may not be prevented.

Indeed, there are steel compositions which are known to have an antimicrobial effect, as disclosed in JP 2000 192259 A, for example. However, these are expensive and susceptible to corrosion. Therefore, such steels are not suitable for use in air-handling systems.

Coatings Having an Antimicrobial Effect are Also Known

For example, US2021/0352907 discloses copper coatings with an antimicrobial effect which preferably contain several copper layers. In order to achieve adequate corrosion protection, a base layer containing zirconium or titanium is also disclosed. Such a coating is too expensive for large-scale industrial use in air-handling systems and is too expensive to manufacture.

For example, WO 2002 087339 discloses a metal sheet which is coated with a polymer containing inorganic particles with antimicrobial effects. However, since the antimicrobial particles are embedded in the polymer in such an arrangement, only a very small portion of the particles can be effective at the surface of the antimicrobial coating. Therefore, the effective period of such a coating is limited to a few years. The adhesion of polymer coatings is also not sufficient for a long service life in air-handling systems. Therefore, such coatings are not suitable for use in air-handling systems.

Furthermore, due to the size and shape of air-handling systems, coatings only be applicable to piece goods are also not suitable.

For example, US 2019/0037841 discloses the production of surfaces which are coated with nano-sized tips and have an antimicrobial effect due to the physical interaction. However, such a surface is too expensive and too sensitive for a large-scale industrial use.

Therefore, the object of the invention is to create a possibility of reliably protecting technical systems, in particular air-handling systems, or components for producing such systems over long periods of time, possibly over their entire lifetime, against microbial contamination and of being able to ensure a permanently high air quality, while at the same time the maintenance and cleaning effort is to be reduced.

This object is achieved by a coating for metal, particularly for a steel strip, comprising a zinc layer for arrangement directly on the surface of the steel strip and a copper layer arranged on the zinc layer, wherein the copper layer has openings. Thus, the zinc layer is only partially covered by copper.

The zinc layer contains zinc such that zinc oxide is formed almost immediately upon coming in contact with pure air. For example, the zinc layer may be made of substantially pure zinc or a zinc alloy, wherein the zinc from the zinc layer reacts with the atmospheric oxygen. The copper layer contains copper so that copper oxide is formed upon coming in contact with air. Both zinc oxide and copper oxide have antimicrobial properties. At the same time, the metal, particularly steel, and the coating are protected from corrosion by the interaction of zinc and copper. In the event of wear, the exposed metals react again with the air and the corrosion protection is quickly restored. In this way, a long-term durability and a long effective period may be ensured. It is possible to apply the coating to a continuous metal strip such that large surfaces may be produced in a cost-effective manner. Therefore, the coating is suitable for use in air-handling systems and contributes permanently to good air quality and public health.

Basically, coatings containing both zinc and copper are already known: For example, US 2015/0314567 shows a coating for steel containing corrosion protection and another metal for improving optical appearance. The corrosion protection may be zinc and the other metal may be copper. In order for the coating to have a higher quality appearance, it is additionally proposed to provide the corrosion protection layer with a texture. Furthermore, in order to improve the corrosion protection, it is proposed to apply an organic coating material onto the copper layer. According to US 2015/0314567, damage to or perforation of the copper layer is therefore to be avoided. With the known coatings, therefore, the interaction of zinc, copper and oxygen has not been used yet to provide a permanently resistant antimicrobial coating.

Advantageous features are described in the dependent claims.

In order to improve the interaction of zinc and copper, the copper layer may be arranged directly on the zinc layer. This may further improve the antimicrobial effect of the coating.

If the coating has already been in contact with air, copper oxide and/or zinc oxide may be formed on the surface of the coating. This has a particularly good antimicrobial effect.

Zinc oxide and/or copper oxide may be formed in the openings by contact of the coating with air. This improves the antimicrobial properties.

In order to improve the antimicrobial effect, the openings may be formed in a sponge structure design. In this case, partially continuous passages extend through the copper layer, where the surface of the coating is formed by the zinc layer, or the copper layer is arranged on the zinc layer in a pattern resembling island groups. This may be achieved by applying a porous copper layer, for example. Therefore, the copper layer may be formed as perforated or porous to improve the antimicrobial effect.

The effect will be particularly good if the openings are arranged uniformly distributed in the copper layer. The distribution is uniform if the openings are arranged such that different regions of the coating having the same size essentially have the same area of openings.

In order to achieve a particularly good effect, the openings may be arranged regularly distributed in the copper layer. In order to achieve a regular distribution of the openings, it may be provided, for example, that, prior to the copper layer being applied, the zinc layer is partially covered or masked, particularly by a fine grid or net. Mesh sizes of 0.01 mm to 5 mm are particularly suitable.

In general, it is advantageous if the openings do not have too large individual areas. Openings with a diameter in the range of about 1 μm to 500 μm facilitate the formation of zinc oxide in the region of the openings and therefore support the antimicrobial properties.

A particularly good effect is achieved if the area of the openings has from 10% to 80%, particularly from 40% to 70%, preferably from 45% to 55%, of the surface of the coating.

The antimicrobial property of the coating is thus particularly strong when 20% to 90%, particularly 30% to 60%, preferably 45% to 55%, of the surface of the zinc layer is covered by the copper layer.

It is particularly advantageous if the copper layer has regions with a diameter of 0.1 mm to 5 mm, particularly with a diameter of 0.5 mm to 2 mm.

An inexpensive coating with a long-term durability may be provided if the copper layer has a layer thickness of 30 nm to 5000 nm, preferably 50 nm to 1500 nm, particularly 100 nm to 1300 nm, particularly preferably 250 nm to 900 nm.

In order to provide a long-term durability and good corrosion protection, the zinc layer may have a layer thickness of 5 μm to 25 μm, particularly 7 μm to 10 μm.

A further aspect of the invention relates to a steel strip comprising a coating described above. The zinc layer is arranged directly on the steel strip. Such a steel strip may be produced in a cost-effective manner and has a long-term durability, wherein the microbial coating achieves a long-term durability and effective period.

A still further aspect of the invention relates to a component for an air-handling system comprising a coating described above, wherein the coating, particularly the copper layer, faces the inner side of the component provided for routing air. The component may particularly be produced from a steel strip described above. Components for air-handling systems are described in DIN EN 1505:1998-2 and DIN EN 1506:2007-9, for example. Both air ducts and functional elements such as fans or doors may be provided with the coating or may be produced from the coated steel strip. The coating protects the inner side of the component from microbial deposits and prevents the air routed in the component from being contaminated.

The invention also relates to an air-handling system comprising such a component. Such an air-handling system may ensure a high air quality and has a reduced cleaning and maintenance effort.

An additional aspect of the invention relates to a method for producing a coating described above or the production of a steel strip described above. In order to enable a large-scale production of the coating in an inexpensive manner, the copper layer is preferably produced by electrochemical deposition, chemical vapor deposition or by physical vapor deposition, particularly sputtering deposition or plasma evaporation.

Another aspect of the invention relates to a coating or a steel strip produced in a method described above.

The effect of a non-limiting exemplary coating is shown by means of the following experiments and figures:

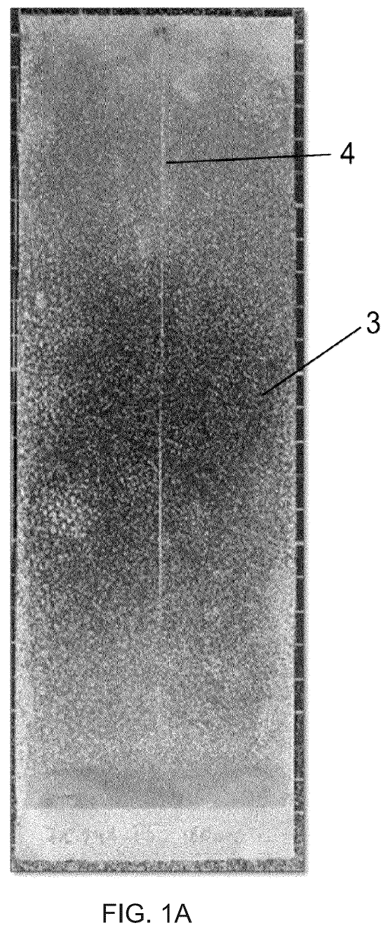

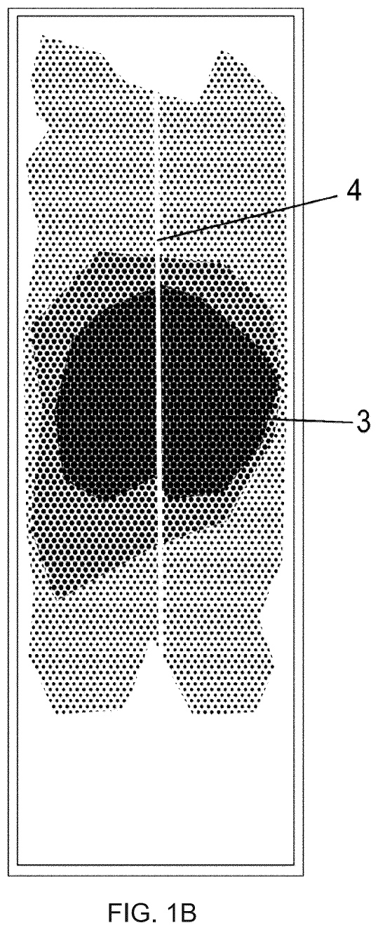

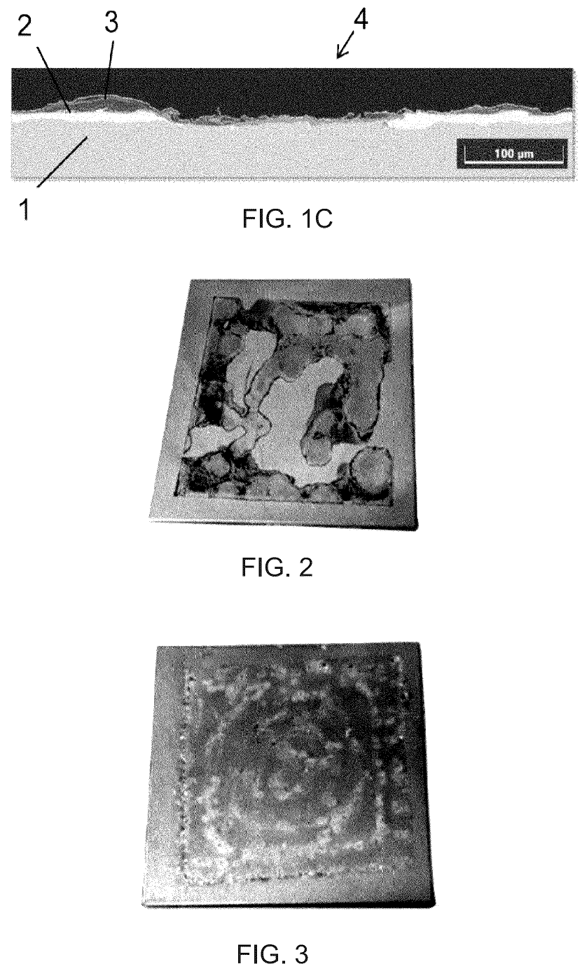

FIG. 1a shows a sample of the first series of samples following the corrosion test after 28 days.

FIG. 1b shows a schematic diagram of the copper coating (image analysis) of the sample of FIG. 1a.

FIG. 1c shows a photograph of a cross-section through a sample of the first series of samples in the region of a corroded crack.

FIG. 2 shows the growth of bacteria on reference 1 after 24 hours.

FIG. 3 shows the growth of bacteria on reference 2 after 24 hours.

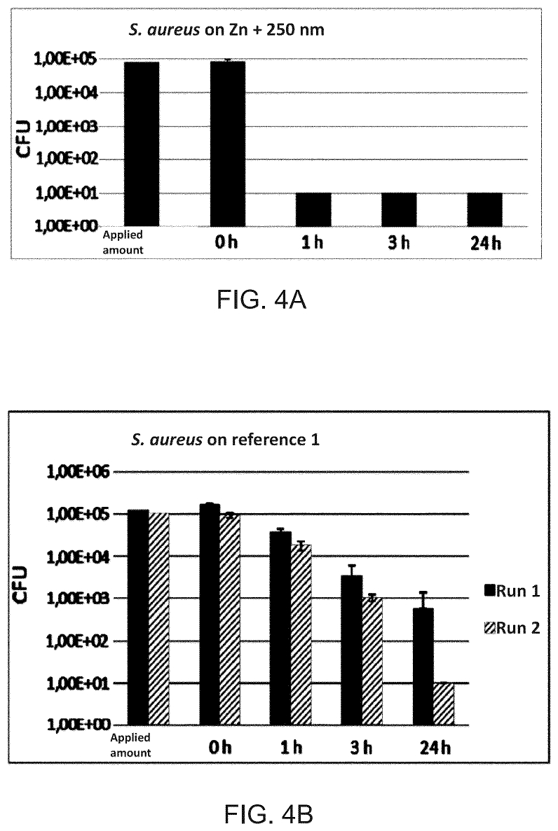

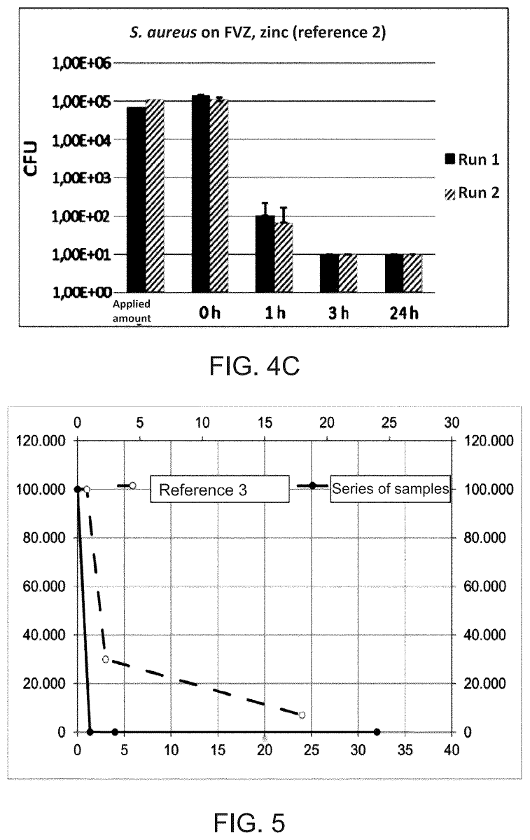

FIG. 4a shows the results of the microbiological examinations of the first series of samples.

FIG. 4b shows the results of the microbiological examinations with reference 1.

FIG. 4c shows the results of the microbiological examinations with reference 2.

FIG. 5 shows the comparison of the microbiological examinations between the samples of the first series of samples and reference 3.

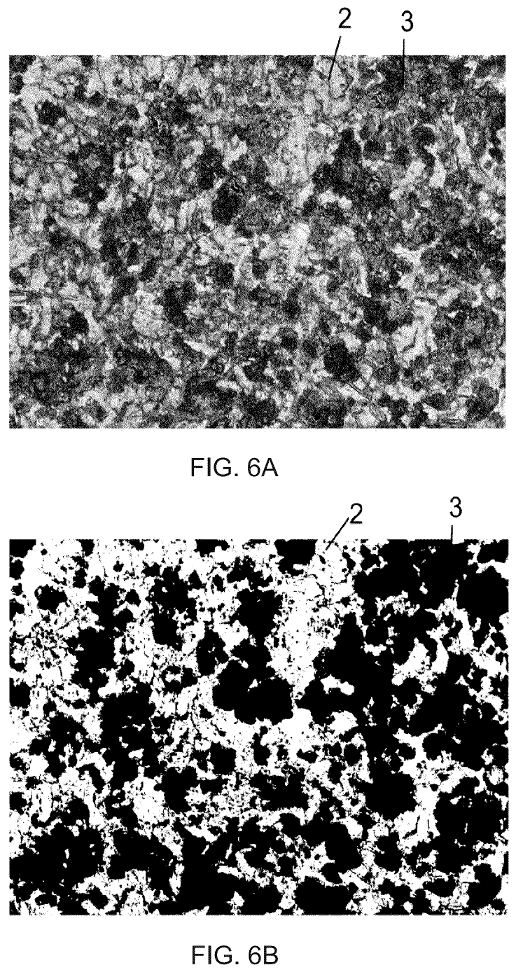

FIG. 6a shows a light microscope image of a sample.

FIG. 6b shows a schematic diagram of the copper coatings (image analysis) of the sample of FIG. 6a.

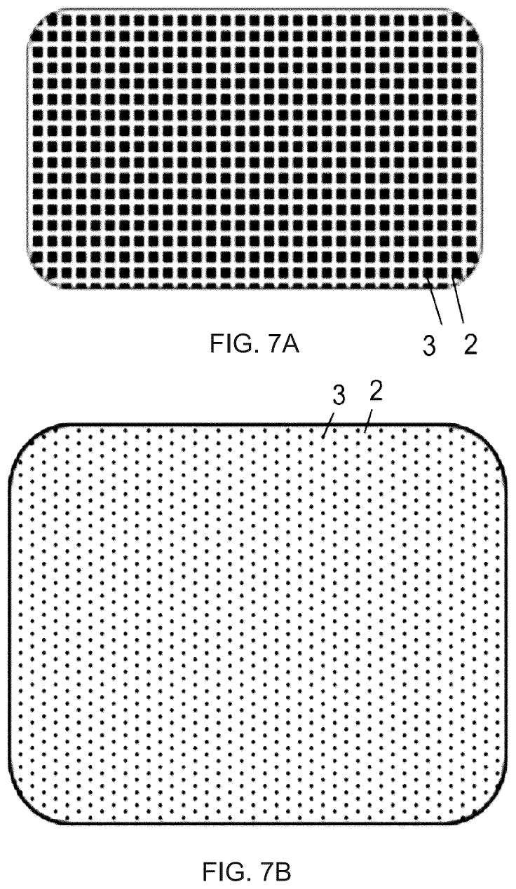

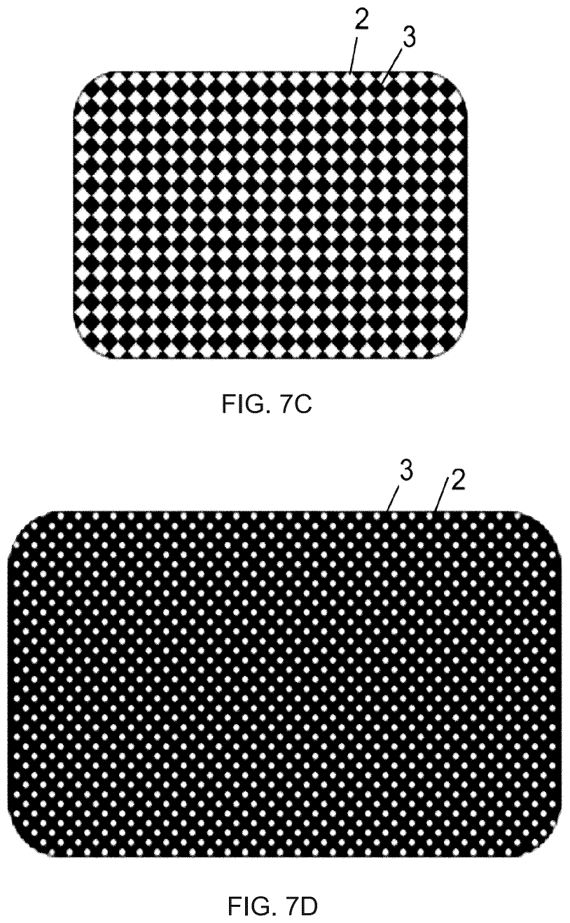

FIG. 7a shows a schematic diagram of a coating with grid-shaped openings.

FIG. 7b shows a schematic diagram of a coating with reticulate openings.

FIG. 7c shows a schematic diagram of a coating with checkered openings.

FIG. 7d shows a schematic diagram of a coating with point-shaped openings.

### A: PRODUCTION OF SAMPLES

A steel strip 1 was coated with a zinc layer 2 having a thickness of 7 pm by hot-dip galvanizing. Subsequently, 20 samples having a size of 90 mm * 250 mm were cut from the sheets. The samples were subjected to a plasma purification, wherein Ar was used as process gas at 5*10⁻³ mbar. The samples were cleaned at 300 V and about 450 watts for 20 seconds, such that an energy density of at least 20 J/cm² was achieved. Immediately afterwards, the 20 samples were coated with a copper layer 3. For this purpose, copper was applied to the sheets by sputtering deposition, wherein Ar at 5*10⁻³ mbar at 300 watts was used in the present experiments.

Two series of samples were produced. 10 samples were coated during a sputtering time of 180 seconds. In this first series of samples, the copper layer 3 had an average layer thickness of 250 nm, wherein the layer thickness had a gradient of 100 nm to 300 nm. In FIG. 1b, the regions having a layer thickness of 100 nm to 200 nm, 200 nm to 250 nm and 250 nm to 300 nm are represented delimited from the outside inwards. The 10 samples of the second series of samples were coated during a sputtering time of 300 seconds. The average layer thickness of the copper layer 3 in this group was 900 nm and had a gradient of 700 nm to 1300 nm. In order to be able to test the influence of damage to the coating on the corrosion behavior of the steel sheet 1, the coating was provided with a crack 4 extending into the steel.

FIG. 6a shows a light microscope image of the surface of a sample of the first series of samples, wherein the dark regions show the copper layer 3 and the light regions show the zinc layer 2 visible through the openings. The openings have an area of approximately 46% of the surface of the coating. In the represented embodiment, the openings are formed in a sponge structure design. The diameter of the openings ranges from about 1 um to 500 um.

FIG. 6b shows the sample of 6a in a schematic view. The shape of the sponge structure design of the openings is even more evident.

FIG. 7a to d each show schematic views of alternative exemplary coatings, wherein the openings are arranged uniformly and regularly. The grid-shaped openings of FIG. 7a and the reticulate openings of FIG. 7b may be obtained by arranging a grid or a mesh on the zinc layer 2 when applying the copper layer 3.

### B: PREPARATION OF THE SAMPLES FOR THE EXAMINATIONS

To simulate the conditions in an air-handling system, the samples were first exposed to KFW weathering in accordance with DIN EN ISO 6270:2-2018. For this condensation water-alternating climate test, the samples were wetted at 40° C. and 100% humidity for 8 hours. Subsequently, the climate chamber was opened and the heater was switched off such that the samples dried under room conditions. The duration of one cycle was 24 hours. Prior to performing the microbiological examinations, the samples were subjected to 7 cycles. For the corrosion resistance examination, an uncoated steel strip (reference 1) and a hot-dip galvanized steel strip (reference 2) were each subjected to one cycle. A sample from the first series of samples was subjected to 28 cycles for corrosion resistance examination.

### B: PERFORMING THE EXAMINATIONS

Examination of the microbial effect of the coating was performed in accordance with ISO 22196. An uncoated cold rolled strip (reference 1), a hot dip galvanized steel strip (reference 2) and a steel strip with a commercially available antimicrobial coating (reference 3) were used as comparisons for the examination. In one run, 3 reference samples were examined, respectively.

The corrosion was assessed visually.

### C: RESULTS OF THE EXAMINATIONS

FIG. 1a shows that no corrosion could be observed in the region of the metal sheet coated with the copper layer 3.

FIG. 1a and c show that the coating of the first series of samples already provides a very good corrosion protection. A protective surface of oxides was formed on the coating. FIG. 1c shows the steel sheet 1, the zinc layer 2 arranged directly on the steel sheet 1, and the copper layer 3 arranged directly on the zinc layer. In the region of the crack 4, the steel strip 1 is covered by a layer 5 of zinc oxide and copper oxide. This confirms that, in case of damage in the coating in the region of the crack 4, the protective surface of oxides was rapidly reproduced, and undesired corrosion could thus be avoided.

In contrast, the sheets of reference 1 in FIG. 2 and reference 2 in FIG. 3 show clear signs of corrosion and microbial infestation after only one cycle.

FIGS. 4a to 4c show the results of the microbial examinations. The mean values of the number of viable bacteria per surface are represented on a logarithmic scale. 0 h shows the number of viable bacteria immediately after inoculation from the sample. 1 h, 3 h and 24 h show the number of viable bacteria after the various incubation times on the sample.

The samples of the first series of samples led to a reduction in the number of bacteria by 100% after only one hour. The growth of Staphylococcus aureus was only slightly restricted on the uncoated cold rolled strip (reference 1), and a reduction by 100% was achieved only after 24 hours. Also, on the galvanized steel strip (reference 2), a reduction of the microbial count by 100% was observed only after 3 hours.

FIG. 5 shows the comparison between the microbial effect of the sample and the reference 3. Again, it was shown that a significantly faster reduction of the microbial count was achieved by the samples. No viable bacteria could be detected anymore within one hour. The same result was shown for the samples of the second series of samples. In contrast, the microbial count decreased at reference 3, but viable pathogens were detectable at each test time.

The experiments show that the coating has, on the one hand, a high corrosion resistance and, on the other hand, also an excellent antimicrobial effect. The possibility of applying the coating to a continuous steel strip allows for the coating to be produced as having a large area and at low cost. Therefore, the coating is particularly suitable for use in air-handling systems and may contribute to permanently maintain a high air quality.

1-15. (canceled)

16. A coating for a steel strip, the coating comprising:
a zinc layer to be placed directly on a surface of the steel strip and a copper layer disposed on said zinc layer;
said copper layer being formed with openings to only partially cover said zinc layer by said copper layer.

17. The coating according to claim 16, wherein at least one of zinc oxide or copper oxide is formed in said openings.

18. The coating according to claim 16, wherein copper oxide and zinc oxide are arranged on a surface of the coating.

19. The coating according to claim 16, wherein said openings are formed in a sponge structure design.

20. The coating according to claim 16, wherein said openings are arranged regularly and/or uniformly distributed in said copper layer.

21. The coating according to claim 16, wherein an area of said openings comprises from 10% to 80% of a surface of the coating.

22. The coating according to claim 21, wherein the area of said openings comprises from 40% to 70% of the surface of the coating.

23. The coating according to claim 21, wherein the area of said openings comprises from 45% to 55% of the surface of the coating.

24. The coating according to claim 16, wherein said copper layer has a layer thickness of 30 nm to 5000 nm.

25. The coating according to claim 24, wherein the layer thickness of said copper layer is 50 nm to 1500 nm.

26. The coating according to claim 25, wherein the layer thickness of said copper layer is 250 nm to 900 nm.

27. The coating according to claim 16, wherein said zinc layer has a layer thickness of 5 μm to 15 μm.

28. The coating according to claim 27, wherein the layer thickness of said zinc layer is 7 μm to 10 μm.

29. A steel strip, comprising a steel strip substrate and a coating according to claim 16, with said zinc layer of said coating being arranged directly on said steel strip substrate.

30. A component for an air-handling system, comprising a coating according to claim 16, wherein the copper layer of said coating is disposed on an inner side of the component for routing air.

31. An air-handling system, comprising at least one component having a coating according to claim 16, with the copper layer of the coating being disposed on an inner side of the at least one component exposed for routing air.

32. A method for producing a coating, the method comprising:
providing a steel strip with the coating according to claim 16 on the steel strip, and thereby producing the copper layer by a process selected from the group consisting of electrochemical deposition, chemical vapor deposition, and physical vapor deposition.

33. The method according to claim 32, which comprises producing the copper layer by sputtering deposition or plasma evaporation.

34. A coating produced by the method according to claim 32.

35. A steel strip produced in the method according to claim 32.
